(19) United States
(12) Patent Application Publication
(10) Pub. No.: US 2015/0048798 A1
(43) Pub. Date: Feb. 19, 2015

(54) CIRCUIT FOR ISOLATION DETECTION FOR VEHICLE BATTERY PACKS

(71) Applicant: MAGNA E-CAR SYSTEMS OF AMERICA, INC., Auburn Hills, MI (US)

(72) Inventors: Drini Godo, Sterling Heights, MI (US); Stephen S. Wieland, Commerce Township, MI (US); Oscar Flores-Bamaca, Macomb, MI (US)

(21) Appl. No.: 14/456,165

(22) Filed: Aug. 11, 2014

Related U.S. Application Data
(60) Provisional application No. 61/865,777, filed on Aug. 14, 2013.

(51) Int. Cl. B60L 11/18

(52) U.S. Cl. CPC B60L 11/1861; B60L 11/1809
USPC 320/134

(57) ABSTRACT

A battery management system, such as for a vehicle having an electrically powered motor that is powered by a plurality of high voltage lithium ion battery packs, includes a circuit operable to detect active isolation for high voltage lithium ion battery packs. The circuit includes a single bias switch and the circuit detects active isolation utilizing a ratio driven algorithm that takes into account analog voltages with the bias switch open and closed. The circuit utilizes a ratio threshold for acceptable isolation breakdown.

### CROSS REFERENCE TO RELATED APPLICATION

The present application claims the filing benefits of U.S. provisional application Ser. No. 61/865,777, filed Aug. 14, 2013, which is hereby incorporated herein by reference in its entirety.

### FIELD OF THE INVENTION

The present invention relates generally to electric vehicles and, more particularly, to batteries and battery management of batteries for an electric vehicle.

### BACKGROUND OF THE INVENTION

Electric vehicles use electric motors that are operated by electrical energy output from a battery pack. These electric vehicles use battery packs that have a plurality of rechargeable battery cells (formed into a pack or module) as a main power source. A voltage of several hundred volts is typically used in powering a main propulsion motor in an electric vehicle.

A battery management system (BMS) may efficiently manage the charge and discharge of the battery or batteries, such as by measuring the battery cell voltages and/or current, such as are disclosed in U.S. Pat. Nos. 8,344,694; 8,315,828; 8,307,223; 8,299,757; 8,273,474; 8,264,201; 8,232,886; 8,174,240; 8,164,305; 8,134,340; 8,134,338; 8,111,071; 8,060,322; 8,054,034 and/or 8,004,249, which are hereby incorporated herein by reference in their entireties. A battery management system or electric vehicle may include a thermal management system for the batteries, such as by utilizing aspects of the systems described in International Publication No. WO 2012/040022, which is hereby incorporated herein by reference in its entirety.

Lithium Ion batteries have a significant amount of safety related controversy following them in the vehicle industry. The search for an alternative energy has been a significant focus with the increase in society's environmental consciousness and also the impacts of the theory of peak oil and the public's transportation costs associated with this inevitable phenomenon. With this comes safety concerns and how we monitor and control different states of an alternative energy such as Lithium based energy to make it a useful alternative for the public but in a safe manner.

The present industry standard technology in battery management systems with regard to active isolation detection utilizes a dual switch bias resistance approach as described in FMVSS45436 and as shown in FIG. 1. With this approach, it is possible to apply a bias resistance in parallel to a single leg (positive or negative) of the high voltage battery isolation resistance in order to determine the resistance of the opposite isolation leg. Due to the nature of the algorithm, which determines the high voltage isolation resistances, the active isolation detection circuit must include a bias switch for both positive and negative isolation resistances. This active isolation routine is accompanied by a passive isolation measurement of the isolation resistances with neither bias resistance switch closed.

### SUMMARY OF THE INVENTION

The present invention provides a circuit and algorithm for active isolation detection for high voltage lithium ion battery packs. The present invention accomplishes active isolation detection with fewer design elements and a ratio driven algorithm that takes into account analog voltages with the bias switch open and closed. This approach is unique in that (i) only one bias switch is required and (ii) a ratio threshold for acceptable isolation breakdown is used in place of resistance calculation.

These and other objects, advantages, purposes and features of the present invention will become apparent upon review of the following specification in conjunction with the drawings.

### BRIEF DESCRIPTION OF THE DRAWINGS

FIG. 1 is a schematic of a current technology dual switch method;

FIG. 2 is a schematic of the single switch approach of the present invention;

FIG. 3 is a schematic of another circuit configuration of the present invention; and

FIG. 4 is a graph showing a Ratio2 example for a worst case circuit analysis.

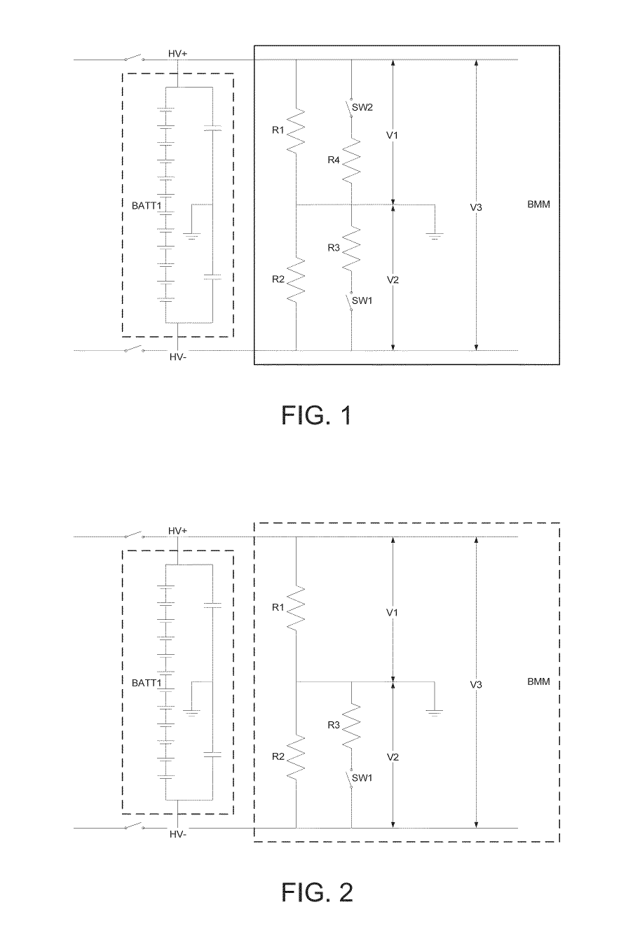

### DESCRIPTION OF THE PREFERRED EMBODIMENTS

The invention depicted in FIG. 2 is a simplified system diagram of the high voltage BMM (battery management module) connected to a generic lithium ion battery pack.

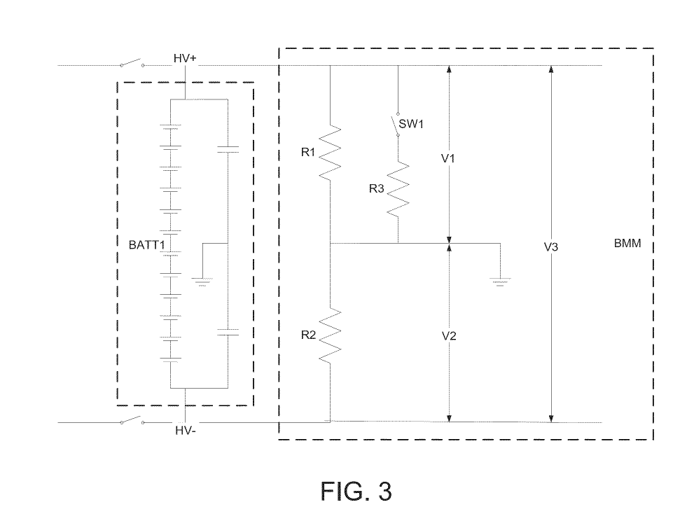

BATT1 represents a lithium ion battery cell pack. Typically, the pack will include Y-capacitors from the battery positive and negative points to vehicle ground, but the lithium battery itself has no direct connection to vehicle ground. Within a BMM, specified isolation is accomplished through R1 and R2. As a note, R1 and R2 may each be comprised of multiple components. A third resistance, R3 may be used to shunt R2 by closing switch SW1 as shown in FIG. 2. Another alternative design would be to have the resistance R3 and SW1 connected in parallel with resistance R1, shunting R1 instead of resistance R2, such as shown in FIG. 3.

Like R1 and R2, R3 may be comprised of multiple components. However, R3 will have a significantly lower resistance. SW1 may be either a mechanical or semiconductor device. However, it must be capable of opening and closing the maximum voltage to which BATT1 can be charged.

Periodically, the BMM must evaluate the battery isolation. This is accomplished via two methods—passive isolation detection and active isolation detection.

Passive isolation detection constitutes measuring voltage V1 and V2 and verifying they are balanced per the expected ratio between R1 and R2 to determine a first ratio (Ratio1):

$$Ratio 1 = \frac{V 1}{V 2} = \frac{R 1}{R 2}$$

Should the ratio between V1 and V2 not be properly balanced, it is an indication of an isolation breakdown of either R1 or R2. Because of resistor tolerances and other considerations of the system, the ratio might have a variation that can be calculated from a worst case analysis of the circuit.

Active isolation detection requires applying the bias resistance R3 via switch SW1. This is done to verify that a properly balanced Ratio1 value is not the result of offsetting isolation breakdowns on both R1 and R2 or an isolation breakdown at the middle of the BATT1 pack. For the circuit of FIG. 2, where the bias resistance R3 and the switch SW1 are applied in parallel with R2, once SW1 is closed, voltages V1 and V2 are measured again to determine a second ratio (Ratio2):

$$Ratio 2 = \frac{V {1}^{′}}{{V2}^{′}} = \frac{R 1}{1 / ( \frac{1}{R 2} + \frac{1}{R 3} )}$$

In the case of the circuit configuration of FIG. 3, where the bias resistance R3 and the switch SW1 shunt the isolation resistance R1, the second ratio would be:

$$Ratio 2 = \frac{{V2}^{′}}{V {1}^{′}} = \frac{R 2}{1 / ( \frac{1}{R 1} + \frac{1}{R 3} )}$$

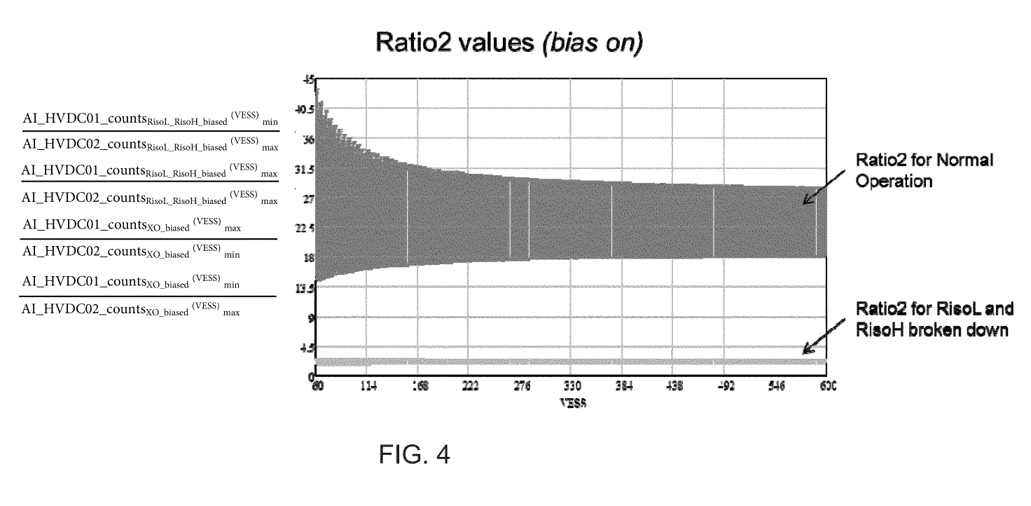

Considering the nominal expected V3 BATT1 battery voltage (FIG. 3), the required minimum isolation per volt of BATT1 potential, and the specified isolation R1 and R2, it is possible to derive a bias resistance R3 that will provide non-overlapping Ratio2 worst-case spans for nominal/acceptable R1 and R2 isolation and instances of unacceptable breakdown of either R1 and/or R2. See FIG. 4 for a graphical rendering of this.

The circuits described above have been analyzed in a Worst-Case Circuit Analysis format to demonstrate that over a given BATT1 range, Ratio2 regions or normal operation and unacceptable isolation breakdown diverge as shown in FIG. 4. Hardware-In-Loop Testing may verify these analytic results.

The battery module or system of the present invention may utilize aspects of the battery management systems described in U.S. patent application Ser. No. 14/203,617, filed Mar. 11, 2014, which is hereby incorporated herein by reference in its entirety.

Therefore, the present invention provides a battery management system for a vehicle having an electrically powered motor that is powered by a plurality of batteries, with the battery management system comprising a circuit and algorithm operable to detect active isolation for high voltage lithium ion battery packs. The circuit detects active isolation utilizing a ratio driven algorithm that takes into account analog voltages with a bias switch open and closed. The circuit comprises a single bias switch and the circuit utilizes a ratio threshold for acceptable isolation breakdown. The present invention accomplishes active isolation detection with fewer design elements and the ratio threshold is used in place of resistance calculation.

Changes and modifications in the specifically described embodiments may be carried out without departing from the principles of the present invention, which is intended to be limited only by the scope of the appended claims as interpreted according to the principles of patent law.

1. A battery management system for a vehicle having an electrically powered motor that is powered by a plurality of high voltage lithium ion battery packs, said battery management system comprising:
a circuit operable to detect active isolation for high voltage lithium ion battery packs;
wherein said circuit comprises a single bias switch;
wherein said circuit detects active isolation utilizing a ratio driven algorithm that takes into account analog voltages with said bias switch open and closed; and
wherein said circuit utilizes a ratio threshold for acceptable isolation breakdown.

2. The battery management system of claim 1, wherein said circuit comprises first and second resistors, and wherein said single bias switch is in series with a third resistor, and wherein said third resistor shunts said second resistor when said single bias switch is closed.

3. The battery management system of claim 1, wherein said circuit determines a first ratio of voltages when said single bias switch is opened and a second ratio of voltages when said single bias switch is closed.
